(19) United States
(12) Patent Application Publication
(10) Pub. No.: US 2014/0087719 A1
(43) Pub. Date: Mar. 27, 2014

(54) Method and Arrangement Related to Interference Between Systems

(71) Applicants: Konstantinos Dimou, Stockholm (SE); Jörgen Karlsson, Sundbyberg (SE); Sverker Magnusson, Stockholm (SE)

(72) Inventors: Konstantinos Dimou, Stockholm (SE); Jörgen Karlsson, Sundbyberg (SE); Sverker Magnusson, Stockholm (SE)

(73) Assignee: TELEFONAKTIEBOLAGET L M ERICSSON (PUBL), Stockholm (SE)

(21) Appl. No.: 14/117,868

(22) PCT Filed: May 16, 2011
(86) PCT No.: PCT/SE2011/050612

§ 371 Date: Nov. 15, 2013

(51) Int. Cl. H04W 16/14

(52) U.S. Cl. CPC H04W 16/14
USPC 455/422.1

(57) ABSTRACT

Method and arrangement for use in a node in a first system associated with a first frequency band for radio communication, for avoiding or reducing interference in a second frequency band associated with a second system, which second frequency band is adjacent to the first frequency band. The method comprises detecting activity of the second system in the second frequency band and determining characteristics of the second system current activity in the second frequency band. The method further comprises adjusting at least one parameter related to radio communication, based on said characteristics, such that interference to the second frequency band, from radio communication associated with the node, is adapted to the second system activity in said second frequency band.

### TECHNICAL FIELD

The invention relates to a method and arrangement for handling of interference between systems using adjacent frequency bands.

### BACKGROUND

Modern communication systems, such as e.g. UMTS (Universal Mobile Telecommunications System), LTE (Long Term Evolution) and LTE-A (Advanced) cause a significantly higher amount of out-of-band interference into adjacent frequency bands than earlier “legacy” communication systems, such as e.g. GSM (Global System for Mobile communications). Such out-of-band interference is also sometimes referred to as “interference leakage”. The main reason for this out-of-band interference is that modern systems typically employ larger, or wider, bandwidth(s) than legacy systems, and that it is more difficult to develop filters which can cut the out-of-band emissions for a relatively large bandwidth than for a relatively narrow bandwidth.

This significantly higher amount of out-of-band interference or emissions may result in violation of e.g. regulations concerning interference caused to other systems, which employ frequency bands adjacent to the frequency band(s) employed by the interference generating, or “disturbing” systems. Examples of systems using spectrum bands which are adjacent to, or are anticipated to be adjacent to, the frequency bands used by e.g. UMTS, LTE and LTE-A in some countries, and thus may be subjected to out-of-band interference from these systems, are e.g.:
the radio navigation and communication systems between airplanes and the ground, such as DME (Distance Measuring Equipment) (962-1213 MHz) and future L-DACS (L-band Digital Aeronautical Communication System) (950-1450 MHz)
the communication/control system used for communication with and control of trains GSM-R (Railway) (876-925 MHz in Europe)

For example, in Europe, an LTE system may use the 900, 1800, and/or 2600 MHz bands. Thus, e.g. an LTE system DL (DownLink) transmission in the 900 MHz frequency band may cause interference to transmissions within the DME or L-DACS systems used for communication with, or control of, e.g. airplanes. Such a scenario is illustrated in FIG. 1. Thus, in a worst case scenario, the out-of-band interference from the LTE DL transmission may e.g. interrupt or disturb important airplane control commands.

A number of solutions have been proposed to mitigate interference between systems using adjacent frequency bands. Most of these proposed solutions focus on the use of a (static) low transmit power in the system causing out-of band interference, or on the use of fixed so-called “guard bands” between the adjacent frequency bands used by different systems or operators. By guard band is meant a frequency band which is not used for communication, but as a buffer for out-of-band interference caused by the systems employing the frequency bands surrounding the guard band. The wider frequency bands used by the systems, the wider guard bands are needed to avoid interference between the systems.

These proposed prior art solutions, however, may cause e.g. coverage problems when the (static) transmit power is too low, and, may further be inefficient e.g. in terms of radio resource usage, by the use of unnecessarily large guard bands based on a worst-case scenario. Further, bandwidth is a scarce resource that is very valuable to the respective authorities or organizations controlling the frequency spectrum in each country. Thus, at least for economical reasons, reserving wide guard bands between systems using adjacent frequency bands is not an attractive idea.

### SUMMARY

It would be desirable to obtain an improved handling of interference between systems using adjacent frequency bands. It is an object of the invention to enable an improved handling of interference between systems using adjacent frequency bands. It is further an object of the invention to provide an efficient method and arrangement for avoiding or reducing interference from a first system to a second system using an adjacent frequency band.

According to a first aspect, a method is provided to be performed in/by a node in a first system associated with a first frequency band for radio communication, for avoiding or reducing interference in a second frequency band associated with a second system, which second frequency band is adjacent to the first frequency band. The method comprises detecting activity of the second system in the second frequency band and determining the characteristics of the current activity of the second system in the second frequency band. The method further comprises adjusting at least one parameter related to radio communication, based on said characteristics, such that interference to the second frequency band, from radio communication associated with the node, is adapted to the second system activity in said second frequency band.

According to a second aspect, an arrangement is provided for use in a node in a first system associated with a first frequency band for radio communication, for avoiding or reducing interference in a second frequency band associated with a second system which second frequency band is adjacent to the first frequency band. The arrangement comprises a functional unit adapted to detect activity of the second system in the second frequency band. The arrangement further comprises a functional unit adapted to determine the characteristics of the second system current activity in the second frequency band. Further, the arrangement comprises a functional unit adapted to adjust at least one parameter related to radio communication, based on said characteristics, such that the interference to the second frequency band is adapted to the second system activity in said second frequency band.

An advantage of the invention is that interference e.g. from mobile systems BSs (Base Stations/eNBs) and/or UEs (User Equipment) to adjacent system services is avoided or reduced by taking appropriate actions only when and where this is needed, without thus sacrificing bandwidth and/or transmission power more than necessary.

Dynamic information about the interference scenarios may be used, and unnecessary worst-case assumptions can be avoided and the constraints on the interfering system can be minimized. The dynamic modifications to the interfering system may be selected as the alternative method that will minimize e.g. the QoS degradation of the interfering system, according to some objective function

The above method and arrangement may be implemented in different embodiments. For example, the at least one adjusted parameter could be one or more of: the bandwidth in which the node operates; the antenna pattern of one or more transmit antennas associated with the node; the transmit power used by the node; the frequency characteristics of a filter in the node; the frequencies used for communication by the node and instructions to one or more mobile terminals served by the node. The instructions to the one or more mobile terminal may be related to e.g. transmit power, frequency usage for uplink communication, filter settings and/or bandwidth.

The at least one parameter may be adjusted such that interference to the second frequency band is reduced when it is determined that the interference does not fulfill a predefined criterion and thus potentially interferes with the second system activity; and, such that the interference to the second frequency band is maintained or increased when it is determined that the interference fulfills said predefined criterion.

The detecting of the activity in the second frequency band may involve performing measurements of activity in the second frequency band; receiving reports of measurements of activity in the second frequency band performed by another node in the first system; receiving explicit information of second system activity in the second frequency band from a node in the second system; receiving information on the geographical position of one or more mobile nodes in the second system; receiving information of the movement pattern of one or more nodes in the second system; receiving information on a time schedule of a node in the second system, and/or receiving information on receiver characteristics of one or more nodes in the second system.

The first system may be e.g. one of UMTS, LTE, LTE-A, and Worldwide Interoperability for Microwave Access (WiMAX).

The second system may be one of Distance Measuring Equipment (DME); L-band Digital Aeronautical Communication System (L-DACS); Global System for Mobile Communications-Railway (GSM-R); a radar system; a system for broadcast; and a satellite based system.

According to a third aspect, a network node is provided for use in a cellular communication system, said network node comprising an arrangement according to the second aspect.

The embodiments above have mainly been described in terms of methods. However, the description above is also intended to embrace embodiments of the arrangements and network node/mobile terminal, adapted to enable the performance of the above described features. The different features of the exemplary embodiments above may be combined in different ways according to need, requirements or preference.

[Will be Completed when the Claims are Finally Decided]

### BRIEF DESCRIPTION OF THE DRAWINGS

The invention will now be described in more detail by means of exemplary embodiments and with reference to the accompanying drawings, in which:

FIG. 1 illustrates a scenario where a cellular communication system may interfere with other systems, such as control systems for planes and trains, according to the prior art.

FIG. 2a is a diagram showing an ideal system frequency spectrum (bold line), and an actual system frequency spectrum (thin line).

FIG. 2b is a diagram showing examples of modified out-of-band interference (dashed and dash-dotted lines) as compared to the out of band interference shown in FIG. 2 (thin solid line), according to exemplifying embodiments.

FIG. 3 is a diagram showing an ideal transmitter frequency spectrum (bold line) in a first system A, and an ideal receiver spectrum (dotted line) in a second system B.

FIGS. 4a-4c are diagrams illustrating inter system interference between a transmitter of a first system A and a receiver of a second system B, according to the prior art (FIG. 4a) and according to different exemplifying embodiments (FIGS. 4b-4c).

FIGS. 5a-5c are diagrams illustrating inter system interference from a real transmitter of a first system A to an ideal receiver of a second system B, according to the prior art (FIG. 5a) and according to different exemplifying embodiments (FIGS. 5b-5c).

FIGS. 6a-6c are diagrams illustrating inter system interference to an ideal transmitter of a first system A from a real receiver of a second system B, according to the prior art (FIG. 6a) and according to different exemplifying embodiments (FIGS. 6b-6c).

FIGS. 7a-7b are schematic views illustrating BSs of a system and the extension of the coverage of different cells of the BSs in absence of (FIG. 7a) and in presence of (FIG. 7b) a train, according to an exemplifying embodiment.

FIG. 8 is a schematic view illustrating, BSs of a system and the extension of the coverage of different cells of the BSs as a train is moving along a track, according to an exemplifying embodiment.

FIG. 9 is a flow chart illustrating a procedure in a node in a communication system, according to an exemplifying embodiment.

FIG. 10 is a block diagram illustrating an arrangement in a node in a communication system, according to an exemplifying embodiment.

FIG. 11 is a block diagram illustrating an arrangement, according to an exemplifying embodiment.

### DETAILED DESCRIPTION

Briefly described, a solution is provided for avoiding interference between systems using adjacent frequency bands. The solution is dynamic, and thus enables e.g. improved utilization of bandwidth resources, as compared to prior art solutions. The provided solution involves dynamic adaptation of the amount of generated out-of-band interference, based on the actual activity in an adjacent frequency band. A system employing a method and arrangement according to an exemplifying embodiment may be described as keeping a “dynamic interference margin” to a system using an adjacent frequency band, and/or as creating a “temporary guard band” to the latter.

Within this document, the expression “a disturbing system” will be used as referring to a system generating out-of-band interference into an adjacent frequency band. Further, the expression “a disturbed system” will be used as referring to a system associated with a frequency band into which a disturbing system generates interference. A disturbed system does not need to be literally disturbed by interference generated by a disturbing system. Further, two “adjacent” frequency bands may or may not be separated by some further frequency band, and still be adjacent.

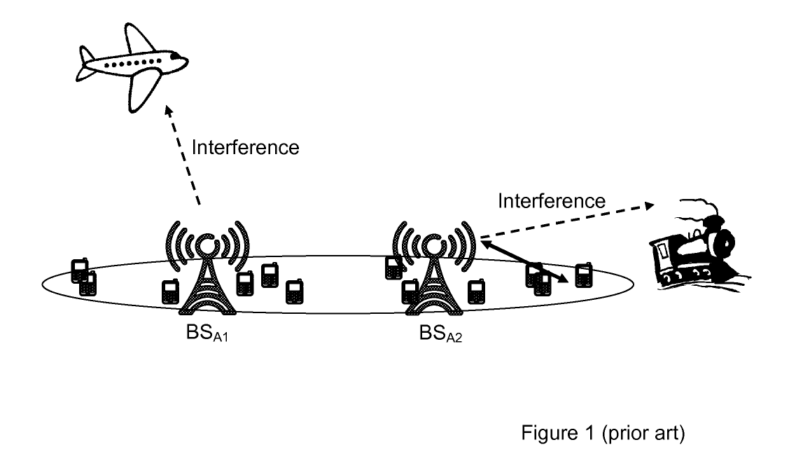

An easily comprehensible example of where the suggested solution may be employed is e.g. in a base station “BS_{A}” of a cellular communication system “A”, where the base station “BS_{A}” is located in a geographical area in close vicinity of an airport or a railway line, as illustrated in FIG. 1, where the frequency band used by the cellular communication system “A” is adjacent to the frequency band(s) used by the airplane or train communication/control system. The activity in the airplane or train communication/control system will be closely related to the presence of airplanes landing or taking off, or of trains passing by. During periods, there will most probably be no plane or train activity, and thus no activity in these communication/control systems.

Typically there are requirements and rules for how much out-of-band interference a communication system may generate. However, theoretically, the base station “BS_{A}” could be allowed to cause “unlimited” out-of-band interference when there is no activity in the airplane or train communication/control system in the example above, since there is no activity which may be disturbed by such interference, and consequently no interference margin to the adjacent frequency band(s) is required. The out-of-band interference generated by “BS_{A}” could then be adapted based on the actual level of activity in the airplane or train communication/control system.

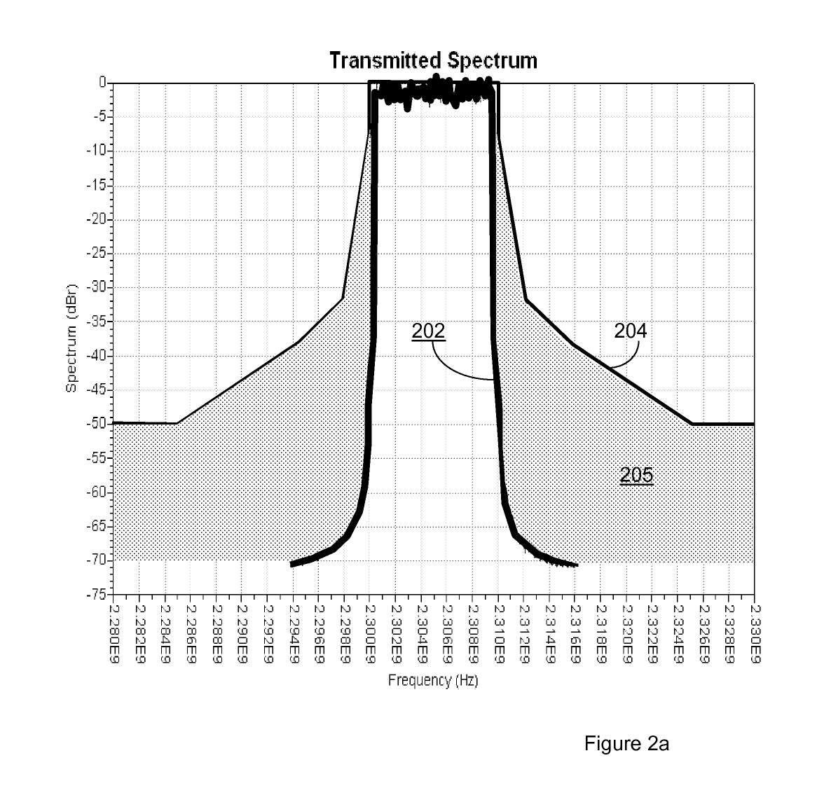

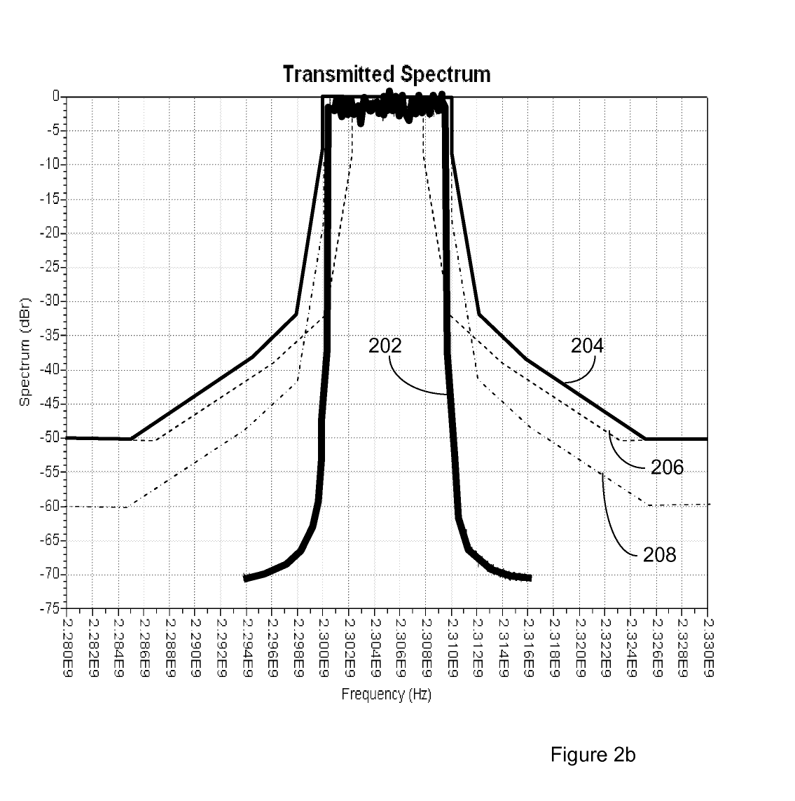

An example of a frequency band 202 associated with a system “A” is outlined in FIG. 2a with a bold solid line. The frequency band 202 may e.g. be reserved for the system “A”, e.g. by that an operator of the system “A” has acquired a license for the frequency band 202 at an auction or similar. The actual frequency band 204, which is affected by communication within system “A” in said frequency band 202, is outlined with a thin solid line (204). The out-of-band interference is thus the shaded area 205 outside the frequency band 202, which comprises signal energy associated with the system “A”.

Thus, when it is detected that an airplane or a train is approaching, a parameter or operating condition in the base station “BS_{A}” may be adjusted such that the communication of said approaching airplane or train will not be disturbed by out-of-band interference caused by base station “BS_{A}” communication. Information on the arrival of an airplane or a train can be obtained by the base station “BS_{A}” in a number of ways. For example, such information could be provided directly from the airplane/train control systems, or, the base station “BS_{A}” could be provided with functionality for obtaining information regarding approaching trains/airplanes either by measuring e.g. received signal strength, receiving reports of measurements performed by other nodes in system A, or, by decoding information from an airplane/train communication channel.

Based on knowledge of parameters, such as, e.g., the position of an airplane or train “B”, the estimated distance from the airplane or train “B” to the base station “BS_{A}”, the velocity and/or the typical behavior of “B”, one or more transmission parameters of the base station may be adjusted during e.g. a given time period, or until the airplane or train “B” has “moved on” or been safely landed.

The base station “BS_{A}” could be provided with information on how the out-of-band performance of the base station “BS_{A}” depends on, or is affected by, the adjustment of different parameters related to radio communication. Having access to such information enables the base station “BS_{A}” to “optimize” the adjustment, i.e. to adjust a parameter or combination of parameters such that a sufficient reduction of the out-of-band interference is provided while maintaining the best possible performance of base station communication. A “sufficient reduction” could be e.g. a reduction which reduces the interference to a level which complies with predefined regulations. Some examples of how the out-of-band interference may be adapted or adjusted are illustrated in FIG. 2b and outlined with a dashed line 206 and a dash-dotted line 208, respectively. If starting with the out-of-band interference outlined by line 204 (205 in FIG. 2a), the out-of-band interference in accordance with the dashed outline 206 may be accomplished e.g. by changing the filter characteristics of an adaptive filter in a node in system “A”. The out-of-band interference in accordance with the dash-dotted outline 208 may be accomplished by e.g. lowering the transmit power of a system node, and/or e.g. tilting the transmit antenna(s) associated with said node downwards.

Other examples of parameters which may be taken into consideration when deciding which parameter(s) to adjust and to which extent are e.g. the number of mobile terminals or UEs served by the base station in question, and further, the power requirements of said UEs resulting from e.g. the UEs' distance from the base station and/or the service(s) utilized by the UEs.

Further, signal characteristics of the interfered system, such as e.g. the interfered system bandwidth and/or frequency usage, may be considered when adapting the out-of-band interference by adjusting an operational condition or parameter in a node, such as e.g. BS_{A}, in the interfering cellular communication system “A”. Taking the signal characteristics of the interfered system into consideration could affect the size or extension of the dynamic interference margin or temporary guard band. This and other aspects of the suggested solution will result in an efficient use of radio resources, due to that the dynamic interference margin to the possibly interfered system will be only as wide as necessary during current conditions.

Moreover, knowledge of the interfered system characteristics and temporary and geographical situation can be used so as to reduce the degradation of the mobile system (e.g. LTE). As an example, the interfered system at a given location can handle high interference from the mobile system within some repetition, e.g. every 1 ms every X ms, etc. For example, the interfered, or “victim”, system may use error correcting codes that may compensate for short time error bursts such that the victim system performance is not affected by such bursts; or, the victim system may be discontinuously connected, e.g. using some TDM scheme.

The adaptation of the out-of-band interference, or “interference leakage”, to current activity and conditions in a system using an adjacent frequency band could be achieved in different ways. For example, the antenna patterns of one or more nodes in the disturbing system could be dynamically adapted, e.g. by antenna tilting or other beam redirection/reconfiguration methods. The main or central antenna beam could be redirected such as to avoid creating interference towards e.g. one or more entities of the disturbed system, such as approaching airplanes, trains or UEs, when such vehicles and/or terminals are detected in the area. Changing the antenna pattern e.g. by tilting the antennas will change the power of out-of-band emissions reaching a certain geographic area, which is one possible way to achieve a dynamic interference margin to an interfered system.

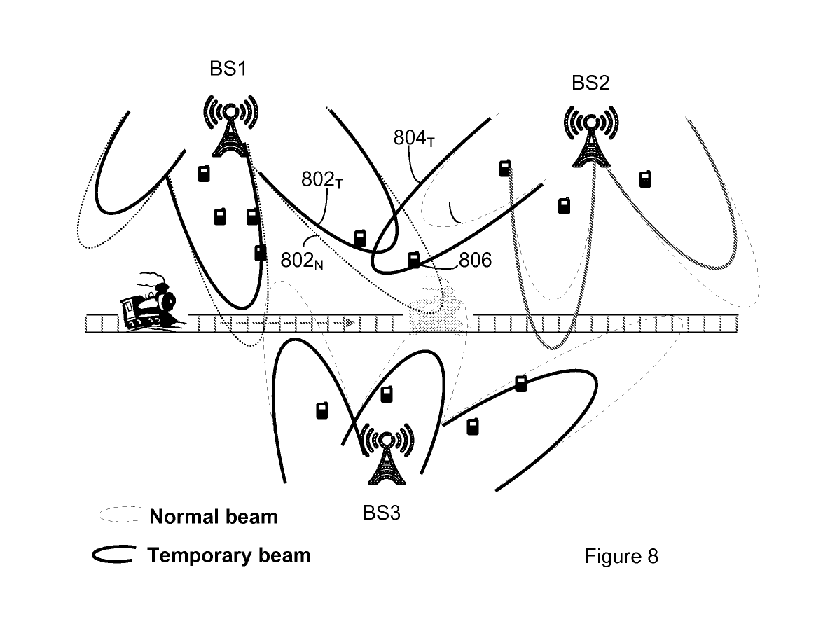

Alternatively or in addition, the transmit power of one or more nodes could be temporarily changed or dynamically adapted, such that an appropriate interference margin is achieved. However, such adaptations should be done in a controlled way, e.g. such that no UEs are suddenly signal-wise “abandoned” outside the signal coverage of the node in question. UEs which are difficult to continue to serve, e.g. when the out-of-band interference should be reduced, may e.g. be handed over to other nodes for continued service (load-sharing). An example of such a load-sharing mechanism is illustrated in FIG. 8, which will be described further below.

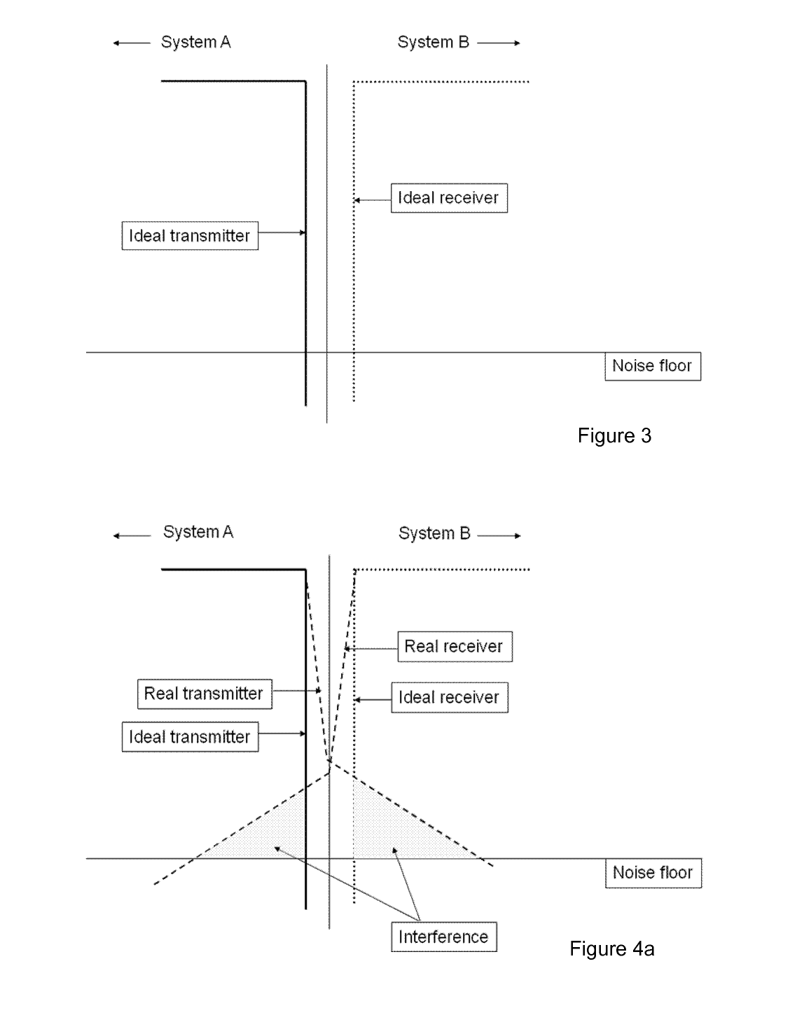

FIGS. 3-6c illustrate, schematically, the frequency spectrum of an ideal/real transmitter in a system A and the frequency spectrum of an ideal/real receiver in a system B, when applying different methods for interference-reduction in accordance with embodiments of the invention.

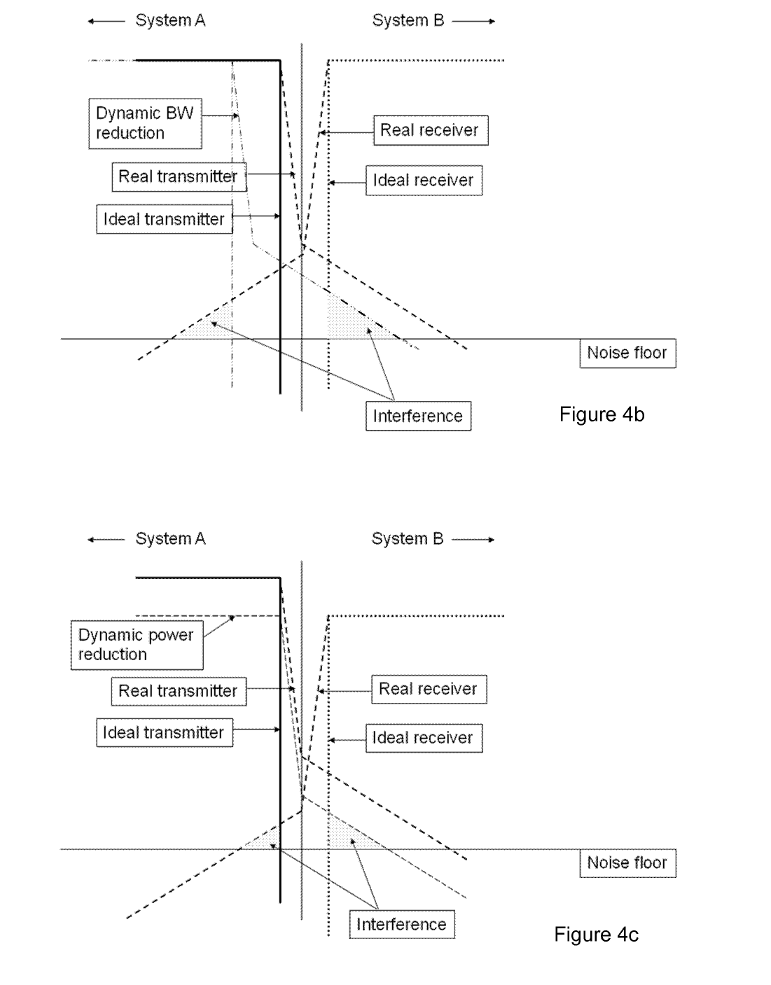

FIG. 3 illustrates the frequency spectrum of an ideal transmitter in a system A and an ideal receiver in a system B. In this ideal case illustrated in FIG. 3, there is no inter-system interference. However, a more realistic situation is illustrated in FIG. 4a, which also shows the frequency spectrum of a real transmitter and a real receiver. In the situation illustrated in FIG. 4a, the inter-system interference is relatively large in both systems. FIGS. 4b and 4c illustrate how the power spectrum of the transmitter of system A, and thus the mutual inter-system interference, changes when applying a dynamic bandwidth reduction (FIG. 4b) and a dynamic power reduction (FIG. 4c), respectively. Another alternative would be to combine bandwidth and power reduction (not illustrated). As can be seen when comparing the FIGS. 4a-4c, the shaded areas illustrating the interference is significantly smaller in FIGS. 4b and 4c than in 4a. Further, it appears as if, in this example, a dynamic power reduction is a more efficient alternative than a dynamic bandwidth reduction. However, the choice of interference-reducing measure may also depend on other factors, such as e.g. location of UEs within a cell (e.g. close to cell border or close to BS).

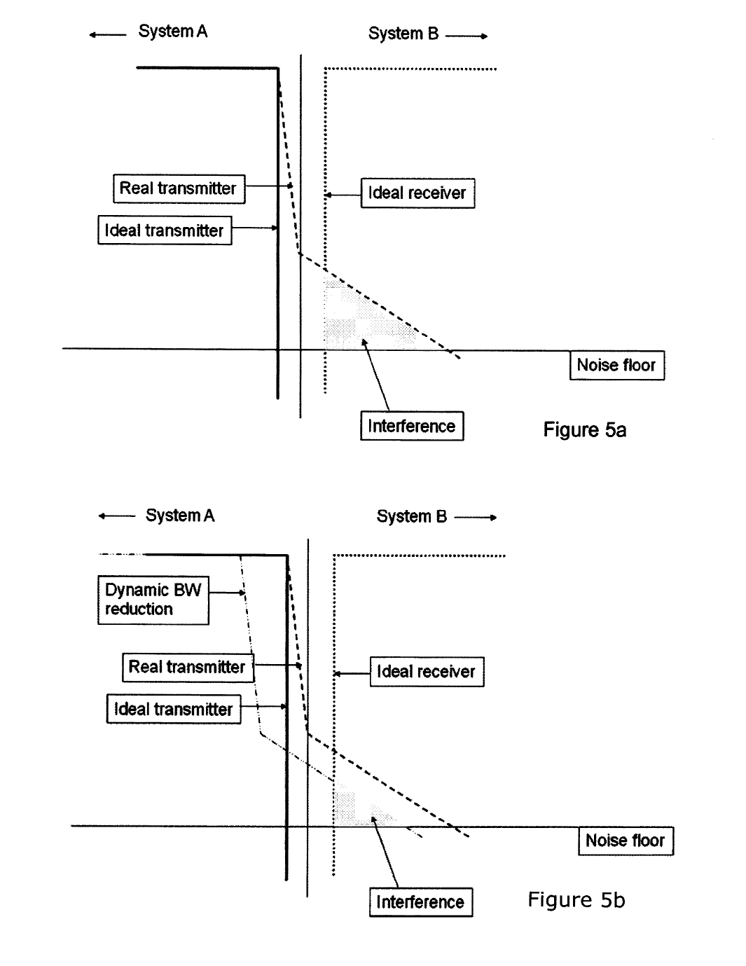

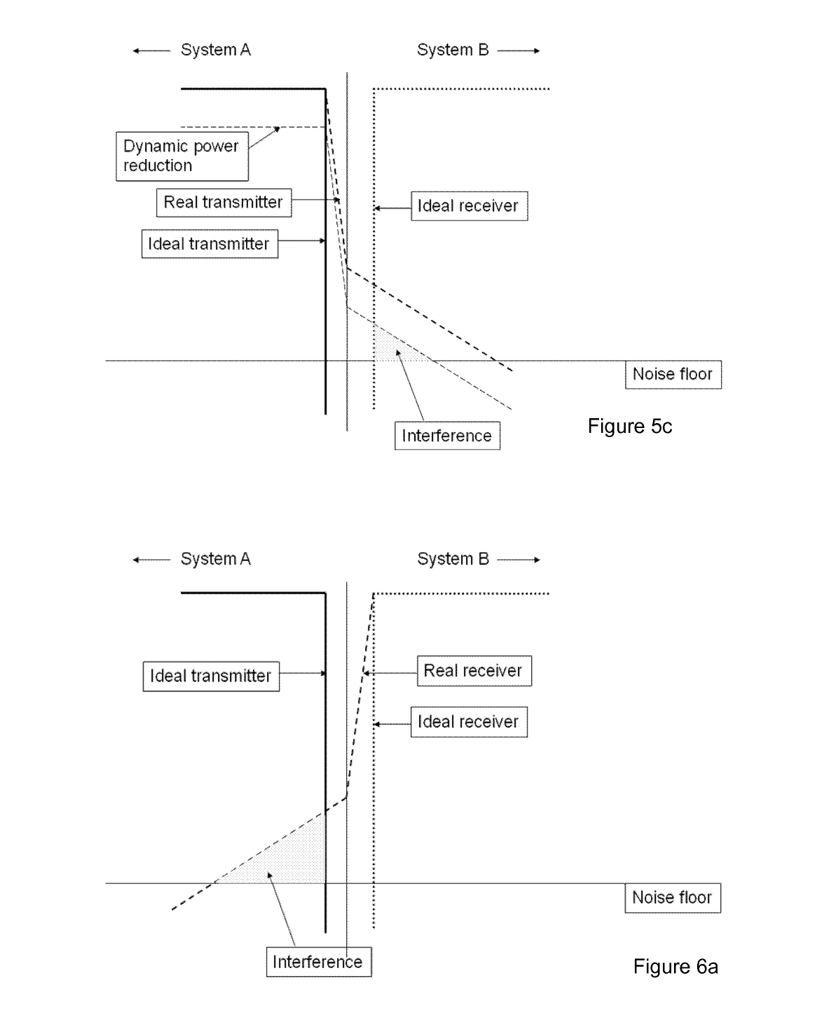

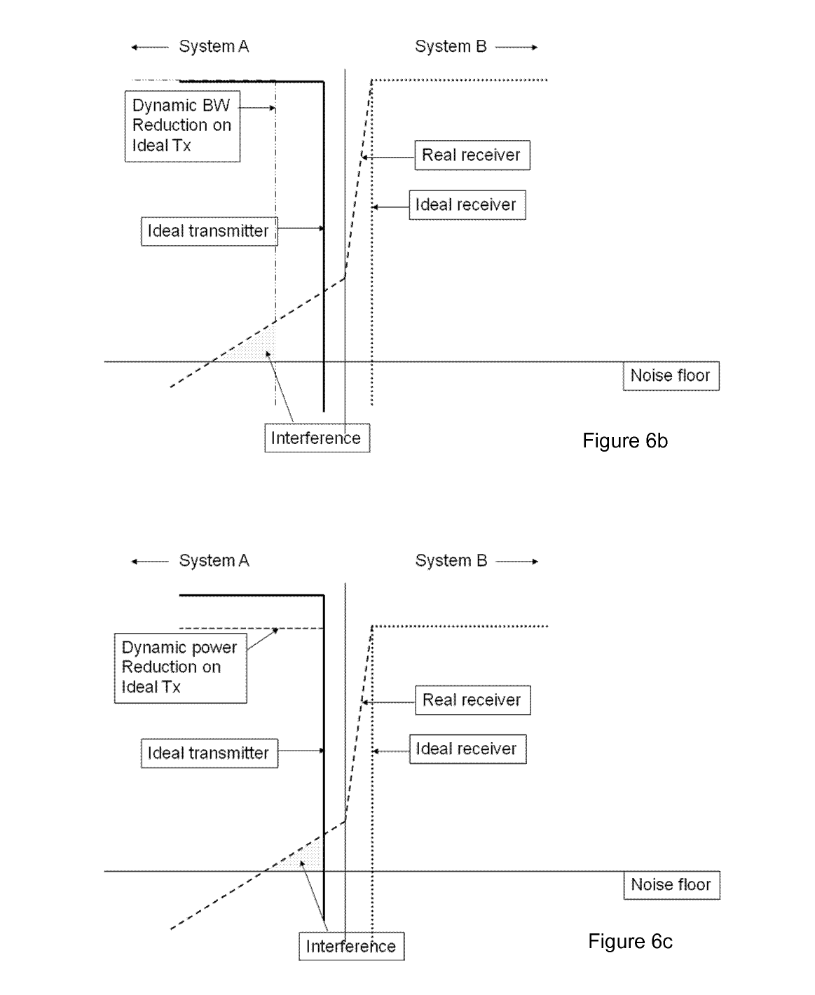

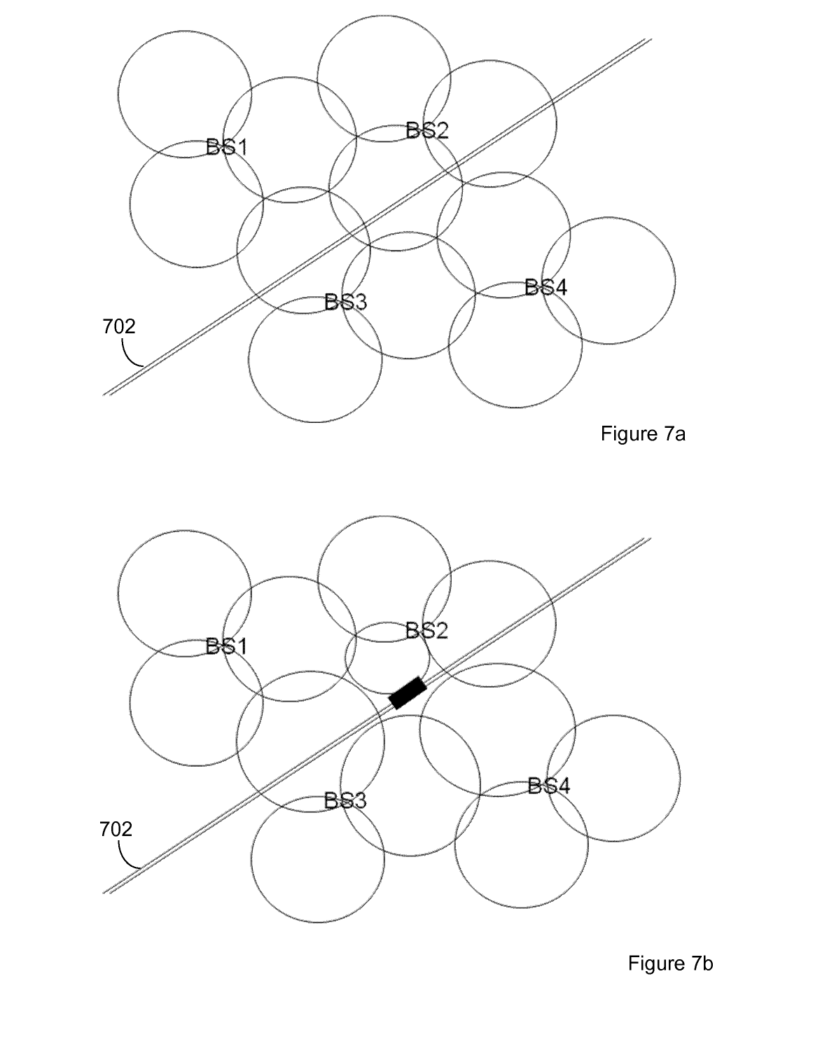

FIGS. 5a-c illustrate a part of what was illustrated in FIGS. 4a-4c, namely the inter-system interference from system A to system B and the effect of the dynamic bandwidth reduction (5b)/dynamic power reduction (5c) of the system-A-transmitter, on said interference from system A to system B. FIGS. 6a-6c, on the other hand, illustrate the inter-system interference from system B to system A and the effect of the dynamic bandwidth reduction (6b)/dynamic power reduction (6c) of the system-A-transmitter, on said interference.

FIGS. 7a-7b illustrate a number of BSs of a first system, each BS generating a number of cells illustrated as circles, and a train track, 702, where trains pass by, which use a second, frequency-wise adjacent, system for communication. In FIG. 7a, no train is present, and thus the first system may use its transmission resources to a maximum. In FIG. 7b, however, a train is present, and the first system is adapted in consideration of the second system, by that one of the cells of BS2 is dynamically reduced.

FIG. 8 illustrates three base stations in a communication system normally emitting permanent antenna lobes or beams as illustrated by the dotted lines. As can be seen in FIG. 8, these permanent beams point in the direction of train rails/tracks. When applying an exemplifying embodiment of the invention, if a train is approaching, the main lobes (beams) of the nearest base station BS1 are adjusted into temporary beams, so as not to create interference to the communication between the train control system and the train. These new adapted temporary beams are illustrated by the bold solid lines in FIG. 8. When the beams of BS1 are adapted, e.g. by redirection or reconfiguration, the beams of a neighbor base station BS2 may be adjusted, such as to cover areas which are left out of coverage due to the adaptation of the beams of BS1. For example, when beam 802N (dotted line) of BS1 is adapted into beam 802T (solid line) in order to avoid interfering with the train communication system, UE 806 is located outside the coverage of BS1. However, in order to continue to provide UE 806 with service, the beam 804N of BS2 is adapted into beam 804T, and the service of UE 806 is transferred to BS2 (load-sharing). When the train has passed by, the beams of BS1 and BS3 will go back to normal (802N, 804N) Similar adjustments of other beams may take place as the train moves along the track.

The use of adaptive antenna patterns and/or dynamic variation of transmit power can be combined e.g. with actions for adjusting the frequency spectrum, or frequency content, of the out-of-band interference. Moreover, the use of adaptive antenna patterns may improve the possibility of using COMP to improve throughput within LTE; e.g. cells with temporarily reduced bandwidth get more support from neighboring cells for the utilized bandwidth.

Further, adaptive filters may be used to achieve a dynamic response to an arising interference situation. One or more adaptive filters in the disturbing system could be used e.g. to suppress the out-of-band interference in accordance with the characteristics of, and the activity in, a disturbed system. The performance of the disturbing system may be somewhat degraded due to e.g. an increased out-of-band-interference suppression by use of adaptive filters. For example, the signal quality in communication within the disturbing system may be degraded by such suppression. However, when comparing the achievable effects of the available alternatives for reducing interference, adaptive filters may still be the preferable solution in some situations.

Some exemplifying embodiments will be described below. In a first exemplifying embodiment, LTE BSs located within a geographical area close to an airport and/or train rails/tracks are equipped with receivers so as to detect signals from airplanes and/or trains. Upon detection of a signal from an airplane or train, a temporary guard band is applied, which is adjusted dynamically depending on the distance to the airplane/train. The received signal strength is used so as to assess this distance. On the basis of the estimated distance between an LTE BS and an airplane or train, the bandwidth of the temporary guard band is assessed. In case the number of users in the cells with a low radio link quality is below a given number N (implying thus there are few or no users far from the BS), then the LTE BS can reduce its DL transmission power during a given period.

In a second exemplifying embodiment, LTE BSs located within a geographical area in the proximity of an airport or train rails/tracks communicate directly, e.g. either via cable, or via micro-wave links, with the airport control towers or with the traffic controllers of airplanes or trains, such that the LTE BSs can obtain information on the arrival of airplanes and their distance to the LTE BSs. Based on this information, temporary guard bands or temporary power reductions are applied by these base stations.

In a third exemplifying embodiment, LTE BSs implementing e.g. the first and/or second embodiment described above, can apply load balancing techniques so as to steer a part of the cell load to neighbor cells, whose controlling base stations do not interfere with the airplanes or trains, during the time period the temporary guard band is applied.

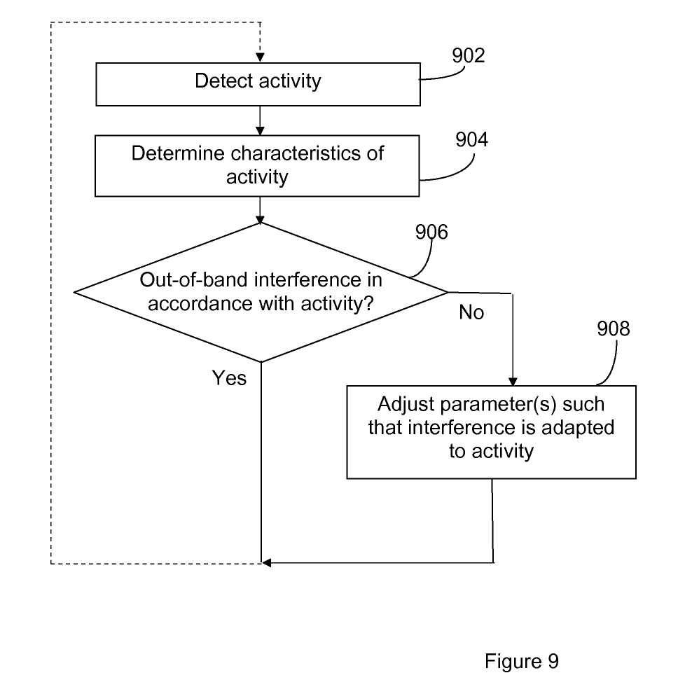

### Exemplifying Procedure, FIG. 9

An exemplifying embodiment of the procedure of avoiding or reducing interference in an adjacent frequency band will now be described with reference to FIG. 9. The procedure could be performed in network node, such as e.g. a base station, or other node in a first wireless communication system. The first communication system, also denoted the “disturbing system”, is assumed to be associated with a first frequency band in which it operates. A second wireless system is assumed to be associated with a second frequency band, which is adjacent to the first frequency band, in which it operates. The first and the second frequency band may be separated by a third frequency band, which is not associated with the first or the second system.

The first communication system may be a system, such as e.g. UMTS (e.g. WCDMA), LTE or LTE-A, operated by a first operator or organization. The second system may be a “dedicated” wireless communication system, such as e.g. the previously mentioned DME, L-DACS or GSM-R, which are used for communication and control of airplanes and trains. The second system may alternatively be a system, such as e.g. UMTS, LTE or LTE-A, operated by a second operator or organization. The second system may further be a radar system comprising e.g. a geographically stationary node generating a rotating/sweeping radar beam; a system for broadcast or a satellite based system. The important factor is that the first and second systems are associated with adjacent frequency bands and that communication within the first system in the frequency band associated with the first system may cause interference in the frequency band associated with the second system, and thereby interfere with the communication within the second system.

Initially, in a network node in the first system, activity of the second system in the second frequency band is detected in an action 902. In order to detect such activity, the network node could e.g. monitor the second frequency band by measuring signal energy in said second frequency band, or, receive reports related to such measurements performed by some other node(s) in the first system, e.g. UE(s); and/or, receive and decode information communicated by the second system within said second frequency band. Alternatively or in addition, the network node could receive information related to activity in the second frequency band. Such information could be provided e.g. by the second system over an alternative communication link, such as e.g. a microwave link or via wired communication. The information provided by the second system could relate to e.g. one or more of: the geographical position of one or more mobile nodes in the second system; the movement pattern of one or more nodes in the second system, a time schedule of a node in the second system and receiver characteristics of one or more nodes in the second system.

One example of receiver characteristic, or ACS (Adjacent Channel Selectivity), is the blocking capability. For example, a given receiver might be able to handle/reduce/cut interference from a neighbor frequency band (at a distance of e.g. 1.25 MHz) up to 60 dB, whilst another receiver might be less powerful and only be able to cut/remove interference from the same neighbor band at a level of 40 dB. Such information on the interfered (second) system could be made known to the interfering (first) system, such that the interfering system can determine an adequate level of e.g. bandwidth and/or transmission power reduction.

From information obtained e.g. in one or more of the ways described above, the network node is able to detect activity of the second system in the second frequency band. The characteristics of the current activity in the second frequency band is then determined in an action 904, e.g. by analysis of performed measurements or other obtained information.

Thus, when having determined the characteristics of the current activity of the second system in the second frequency band, it may be determined in an optional action 906, if the out-of-band interference caused by communication associated with the network node, i.e. DL from the network node and/or UL to the network node, is in accordance with the characteristics of the current activity of the second system in the second frequency band, or if the out-of-band interference should be reduced or may be increased (within allowed boundaries). By “being in accordance with” is here meant that the out-of-band interference fulfils predefined requirements of to which extent out-of-band interference from the first system may interfere with the second system, while, at the same time, the radio resources in the first system are utilized e.g. to a sufficiently high extent or to an as high extent as possible. That is, the out-of-band interference should not be as high or strong as to interfere with the second system activity, but neither be suppressed to an unnecessarily low level.

Thus, when appropriate, at least one parameter related to radio communication is adjusted in an action 908, such that the interference to the second frequency band from radio communication associated with the network node is adapted to the second system activity in said second frequency band. Examples of parameters which may be adjusted are: the bandwidth in which the network node operates; the antenna pattern of one or more transmit antennas associated with the network node; the transmit power used by the network node; the frequency characteristics of a filter in the network node; the frequencies used for communication by the network node; and instructions to other nodes such as e.g. UEs served by the node.

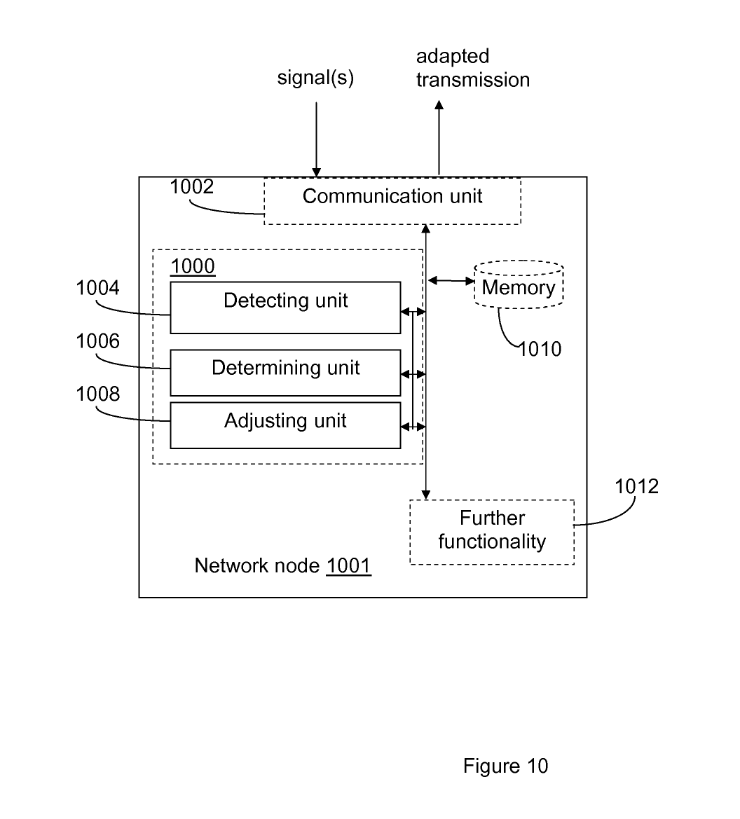

### Exemplifying Arrangement, FIG. 10

Below, an exemplifying arrangement 1000, adapted to enable the performance of the above described procedure of avoiding or reducing interference in an adjacent frequency band will be described with reference to FIG. 10. The arrangement is suitable for use in, and is illustrated as being located/integrated in, a network node 1001, such as e.g. a base station, or other node in a first communication system being associated with a first frequency band, in which the first system operates. The arrangement 1000 is further illustrated as to communicate with other entities via a communication unit 1002, which may be considered to comprise conventional means for wireless and/or wired communication. The arrangement or receiving node may further comprise other functional units 1012, such as e.g. adaptive filters, antenna control mechanisms and/or functional units providing regular base station functions, such as e.g. serving mobile terminals. The arrangement or receiving node may further comprise one or more storage units 1010. The first and second system may be of various types, as previously described in conjunction with FIG. 9.

The arrangement 1000 comprises a detecting unit 1004, which is adapted to detect activity of a second system in a second frequency band, which is adjacent to the first frequency band. For example, the detecting unit could be adapted to monitor the second frequency band by measuring signal energy in said second frequency band; by receiving and decoding information communicated by the second system within said second frequency band; Alternatively receive or retrieve information related to the activity in the second frequency band, which information could be received or retrieved e.g. from the second system over an alternative communication link, such as e.g. a microwave link or via wired communication link.

The arrangement further comprises a determining unit 1006, which is adapted to determine the characteristics of the second system current activity in the second frequency band. Said characteristics could relate to one or more of e.g.: which frequencies that are used by the second system for transmission and/or reception, and to which extent; the time period during which the activity is expected to proceed; the expected development of the activity; a periodicity of the activity; and, the geographical extension of the activity. “Expected development” may relate to factors such as e.g. modulation format or modulation concept used by the second system.

The arrangement, e.g. the determining unit 1006 or some additional optional unit, may further be adapted to determine whether the interference to the second frequency band fulfills a predefined requirement, given the characteristics of the second system activity in the second frequency band. The predefined criterion may relate to an acceptable level of interference in the frequencies within the second frequency band, which are affected by the second system activity. The predefined criterion may e.g. be based on regulations regarding allowed levels of out-of-band interference and/or on the result of negotiations between e.g. different operators. Such regulations may be related to “blocking” and/or Adjacent Channel Leakage Ratio (ACLR). For HSPA (High Speed Packet Access) and LTE, for example, information related to such allowed levels may be found in 3GPP specifications.

Thus, the arrangement may be adapted to adjust the at least one parameter such that the interference to the second frequency band is reduced when it is determined that the interference does not fulfill the predefined criterion, and thus potentially interferes with the second system activity; and to adjust the at least one parameter such that the interference to the second frequency band is maintained or increased when it is determined that the interference fulfills the predefined criterion.

The arrangement further comprises an adjusting unit 1008, which is adapted to adjust at least one parameter related to radio communication, in the network node, based on said characteristics, such that the interference to the second frequency band is adapted to the second system activity in said second frequency band. For example, the parameter(s) which is/are adjusted could be parameters such as e.g.: the bandwidth used by the network node for transmission; the frequencies used for communication with mobile terminals served by the network node, when applicable; the settings of one or more antennas associated with the network node, thus controlling the antenna pattern of said antennas; the transmit power used by the network node; instructions to mobile terminals served by the network node, related to e.g. transmit power and frequency usage; filter settings, thus controlling e.g. the frequency characteristics of one or more adaptive filters in the network node.

The functional units described above may be implemented in software and/or hardware, depending on e.g. preference.

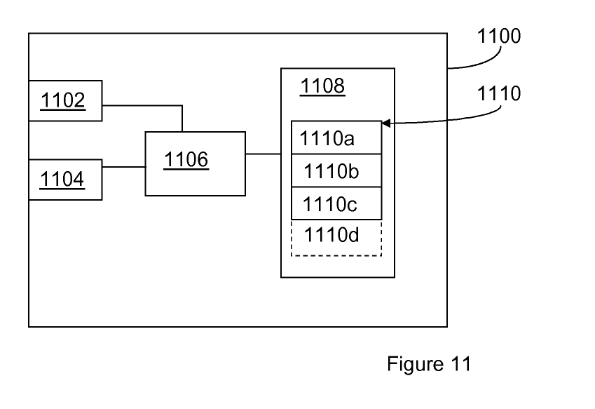

### Exemplifying Arrangement, FIG. 11

FIG. 11 schematically shows an embodiment of an arrangement 1100 in a network node, which also can be an alternative way of disclosing an embodiment of the arrangement in a network node illustrated in FIG. 10. Comprised in the arrangement 1100 are here a processing unit 1106, e.g. with a DSP (Digital Signal Processor). The processing unit 1106 may be a single unit or a plurality of units to perform different actions of procedures described herein. The arrangement 1100 may also comprise an input unit 1102 for receiving signals from other entities, and an output unit 1104 for providing signal(s) to other entities. The input unit 1102 and the output unit 1104 may be arranged as an integrated entity.

Furthermore, the arrangement 1100 comprises at least one computer program product 1108 in the form of a non-volatile memory, e.g. an EEPROM (Electrically Erasable Programmable Read-Only Memory), a flash memory and a hard drive. The computer program product 1108 comprises a computer program 1110, which comprises code means, which when executed in the processing unit 1106 in the arrangement 1100 causes the arrangement and/or the network node to perform the actions of the procedure described earlier in conjunction with FIG. 9.

The computer program 1110 may be configured as a computer program code structured in computer program modules. Hence, in an exemplifying embodiment, the code means in the computer program 1110 of the arrangement 1100 comprises a detecting module 1110a for detecting activity in an adjacent frequency band. The computer program further comprises a determining module 1110b for determining the characteristics of any detected activity in the adjacent frequency band. The computer program 1110 further comprises an adjusting module 1110c for adjusting one or more parameters, based on the characteristics of the activity, such that interference to the second frequency band, from radio communication associated with the network node, is adapted to the second system activity in said second frequency band. The computer program 1110 could further comprise other modules 1110d for providing other desired functionality.

The modules 1110a-c could essentially perform the actions of the flow illustrated in FIG. 9, to emulate the arrangement in a receiver node illustrated in FIG. 10. In other words, when the different modules 1110a-c are executed in the processing unit 1106, they may correspond to the units 404-408 of FIG. 10.

Although the code means in the embodiment disclosed above in conjunction with FIG. 11 are implemented as computer program modules which when executed in the processing unit causes the arrangement and/or network node to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the network node.

Below, some example details on implementation of the suggested solution e.g. in an LTE system will be discussed.

Implementing e.g. temporary modification of the system bandwidth may require some adjustments or additions to e.g. standard specifications. For example, if a system operating within a 20 MHz frequency channel is adjusted to temporarily operate within an 18 MHz frequency channel, the number of available Physical Resource Blocks (PRBs) is reduced. Thus, it should be seen to e.g. that the DL PDCCH can be carried within the remaining amount of PRBs. Organizations such as the 3GPP (3^{rd} Generation Partnership Project) may for example need to specify performance requirements for this new amount of PRBs.

When modifying the operating bandwidth within a cell, this information should be provided to e.g. mobile terminals camping on the cell, at least when appropriate. Said mobile terminals may be notified of the change in operating bandwidth via e.g. the broadcast channel of the cell.

While the procedure as suggested above has been described with reference to specific embodiments provided as examples, the description is generally only intended to illustrate the inventive concept and should not be taken as limiting the scope of the suggested methods and arrangements, which are defined by the appended claims. While described in general terms, the methods and arrangements may be applicable e.g. for different types of communication systems, using commonly available communication technologies using different power and/or bandwidth, such as e.g. WCDMA, LTE, LTE-A, WiMAX (Worldwide Interoperability for Microwave Access), GSM, UMTS, radar systems, satellite systems or broadcast technologies.

It is also to be understood that the choice of interacting units or modules, as well as the naming of the units are only for exemplifying purpose, and client and server nodes suitable to execute any of the methods described above may be configured in a plurality of alternative ways in order to be able to execute the suggested process actions.

It should also be noted that the units or modules described in this disclosure are to be regarded as logical entities and not with necessity as separate physical entities.

1-10. (canceled)

11. A method in a node in a first system associated with a first frequency band for radio communication, for avoiding or reducing interference in a second frequency band associated with a second system and adjacent to the first frequency band, the method comprising:
detecting activity of the second system in the second frequency band,
determining characteristics of the activity, and
adjusting at least one parameter related to radio communication, based on said characteristics, such that interference to the second frequency band from radio communication associated with the node is adapted to the activity.

12. The method according to claim 11, wherein the at least one adjusted parameter is one or more of:
the bandwidth in which the node operates,
the antenna pattern of one or more transmit antennas associated with the node,
the transmit power used by the node,
the frequency characteristics of a filter in the node,
the frequencies used for communication by the node, and
instructions to one or more mobile terminals served by the node, related to:
transmit power,
frequency usage for uplink communication,
filter settings, or
bandwidth.

13. The method according to claim 11, wherein the at least one parameter is adjusted such that interference to the second frequency band is reduced when it is determined that the interference does not fulfill a predefined criterion and thus potentially interferes with the activity, and such that the interference to the second frequency band is maintained or increased when it is determined that the interference fulfills said predefined criterion.

14. The method according to claim 11, wherein detecting the activity includes one or more of:
performing measurements of activity in the second frequency band,
receiving reports of measurements of activity in the second frequency band performed by another node in the first system,
receiving explicit information of activity of the second system in the second frequency band from a node in the second system,
receiving information on the geographical position of one or more mobile nodes in the second system,
receiving information of the movement pattern of one or more nodes in the second system,
receiving information on a time schedule of a node in the second system, and
receiving information on receiver characteristics of one or more nodes in the second system.

15. The method according to claim 11, wherein the first system is one of:
Universal Mobile Telecommunications System (UMTS),
Long Term Evolution (LTE),
LTE-Advanced (LTE-A), and
Worldwide Interoperability for Microwave Access (WiMAX)

16. The method according to claim 11, wherein the second system is one of:
Distance Measuring Equipment (DME),
L-band Digital Aeronautical Communication System (L-DACS),
Global System for Mobile Communications-Railway (GSM-R),
a radar system,
a system for broadcast, and
a satellite based system

17. An arrangement for use in a node in a first system associated with a first frequency band for radio communication, for avoiding or reducing interference in a second frequency band associated with a second system and adjacent to the first frequency band, the arrangement comprising:
a detecting unit, adapted to detect activity of the second system in the second frequency band,
a determining unit, adapted to determine the characteristics of the activity, and
an adjusting unit, adapted to adjust at least one parameter related to radio communication, based on said characteristics, such that the interference to the second frequency band is adapted to the activity.

18. The arrangement according to claim 17, wherein the arrangement is adapted to determine whether the interference to the second frequency band fulfills a predefined requirement, given the characteristics of the activity, and further adapted to adjust the at least one parameter such that the interference to the second frequency band is reduced when it is determined that the interference does not fulfill the predefined criterion, and thus potentially interferes with the activity, and to adjust the at least one parameter such that the interference to the second frequency band is maintained or increased when it is determined that the interference fulfills the predefined criterion.

19. The arrangement according to claim 17, wherein the arrangement is adapted to detect the activity based on one or more of:
performing measurements of activity in the second frequency band,
receiving reports of measurements of activity in the second frequency band performed by another node in the first system,
receiving explicit information of activity of the second system in the second frequency band from a node in the second system,
receiving information on the geographical position of one or more mobile nodes in the second system,
receiving information of the movement pattern of one or more nodes in the second system,
receiving information on a time schedule of a node in the second system, and
receiving information on receiver characteristics of one or more nodes in the second system.

20. The arrangement according to claim 16, wherein the arrangement comprises a network node.

21. A method in a node in a first radio system comprising:
detecting an activity associated with a second radio system that is subject to interference arising from operation of the first radio system;
determining one or more adaptations for the first radio system responsive to detecting the activity, to reduce or prevent interference with the second radio system; and
adapting operation of the first radio system according to the determined adaptations.
